(19) United States
(12) Patent Application Publication
(10) Pub. No.: US 2013/0215567 A1
(43) Pub. Date: Aug. 22, 2013

(54) INFORMATION PROCESSOR

(71) Applicant: Kabushiki Kaisha Toshiba, (US)

(72) Inventors: Hirofumi MORITA, Higashiyamato-shi (JP); Hiroki TAKENOUCHI, Akishima-shi (JP); Satoshi YOKOTE, Ome-shi (JP)

(73) Assignee: KABUSHIKI KAISHA TOSHIBA, Tokyo (JP)

(21) Appl. No.: 13/719,813

(22) Filed: Dec. 19, 2012

(30) Foreign Application Priority Data
Feb. 16, 2012 (JP) 2012-031512

(51) Int. Cl. G06F 1/16

(52) U.S. Cl. CPC G06F 1/1637; G06F 1/1633
USPC 361/679.27; 361/679.55

(57) ABSTRACT

An information processor includes an enclosure and a wireless communication module. The enclosure includes a first face, a second face, a plurality of corner portions and a center portion. The first face includes an input region and a surrounding region that extends around the input region. The second face is opposite to the first face. The center portion is distant from the corner portions. The wireless communication module has a side extending along the first face or the second face in which at least part of the side is closer to the corner portion overlapping with the surrounding region, the wireless communication module is configured to communicate through at least the second face.

### CROSS-REFERENCE TO RELATED APPLICATIONS

This application is based upon and claims the benefit of priority from Japanese Patent Application No. 2012-031512, filed Feb. 16, 2012, the entire contents of which are incorporated herein by reference.

### FIELD

Embodiments described herein relate generally to an information processor mounting a wireless communication module thereon.

### BACKGROUND

There is a portable information processor mounting a near field communication (NFC) module or the like thereon in order to read information in an IC chip of a card or tag incorporating the IC chip therein, or a portable information medium such as a cell phone in a non-contact manner. In the information processor, the NFC module is arranged between a touch pad installed on the top of the main body for operating a cursor on a display screen, and the main body, or between a liquid crystal panel of the display screen and a top plate covering the back of the liquid crystal panel. When a card or cell phone incorporating an IC chip therein is placed near the touch pad incorporating the NFC module or over the display face of the display panel, wireless communication is made between the NFC module and the IC chip or cell phone so that information can be read from the IC chip or cell phone or new information can be written therein.

An apparatus that makes wireless communication such as NFC module is expected not only to read information from an IC chip in a card but also to be used for communication with an information processor or an electronic device in the future. In the information processor, an improvement in user convenience for the communication form is desired.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an information processor according to a first embodiment;

FIG. 2 is a plan view of the information processor of FIG. 1 viewed from a first face;

FIG. 3 is a cross-section view of the information processor taken along the line F3-F3 in FIG. 2;

FIG. 4 is a perspective view showing a state in which the information processors of FIG. 1 make communication;

FIG. 5 is a perspective view showing an information processor according to a second embodiment;

FIG. 6 is a perspective view showing an information processor according to a third embodiment;

FIG. 7 is a perspective view showing an information processor according to a fourth embodiment;

FIG. 8 is a cross-section view showing part of the information processor of FIG. 7;

FIG. 9 is a perspective view showing an information processor according to a fifth embodiment;

FIG. 10 is a perspective view showing a state in which a holder of the information processor of FIG. 9 is opened;

FIG. 11 is a perspective view in which a security cable is attached to the information processor of FIG. 9;

FIG. 12 is a perspective view showing an information processor according to a sixth embodiment;

FIG. 13 is a perspective view showing an information processor according to a seventh embodiment;

FIG. 14 is a side view of the information processor of FIG. 13;

FIG. 15 is a perspective view showing an information processor according to an eighth embodiment;

FIG. 16 is a side view of the information processor of FIG. 15;

FIG. 17 is a perspective view showing an information processor according to a ninth embodiment;

FIG. 18 is a cross-section view in which part of a holder in the information processor of FIG. 17 is enlarged;

FIG. 19 is a perspective view showing an information processor according to a tenth embodiment;

FIG. 20 is a cross-section view in which part of a holder in the information processor of FIG. 19 is enlarged;

FIG. 21 is a side view showing an information processor according to an eleventh embodiment;

FIG. 22 is a side view showing an information processor according to a twelfth embodiment; and

FIG. 23 is a flowchart showing security control when an information medium is left in the holder in the information processor according to the second to twelfth embodiments.

### DETAILED DESCRIPTION

Various embodiments will be described hereinafter with reference to the accompanying drawings.

In general, according to one embodiment, an information processor comprises an enclosure and a wireless communication module. The enclosure includes a first face, a second face, a plurality of corner portions and a center portion. The first face includes an input region that receives an input and a surrounding region that extends around the input region. The second face is opposite to the first face. The corner portions are included in two outer peripheries of the first face and the second face. The center portion is distant from the corner portions and houses a component therein. The wireless communication module has a side extending along the first face or the second face in which at least part of the side is arranged inside the enclosure closer to the corner portion at a portion overlapping with the surrounding region, the wireless communication module is configured to communicate through at least the second face.

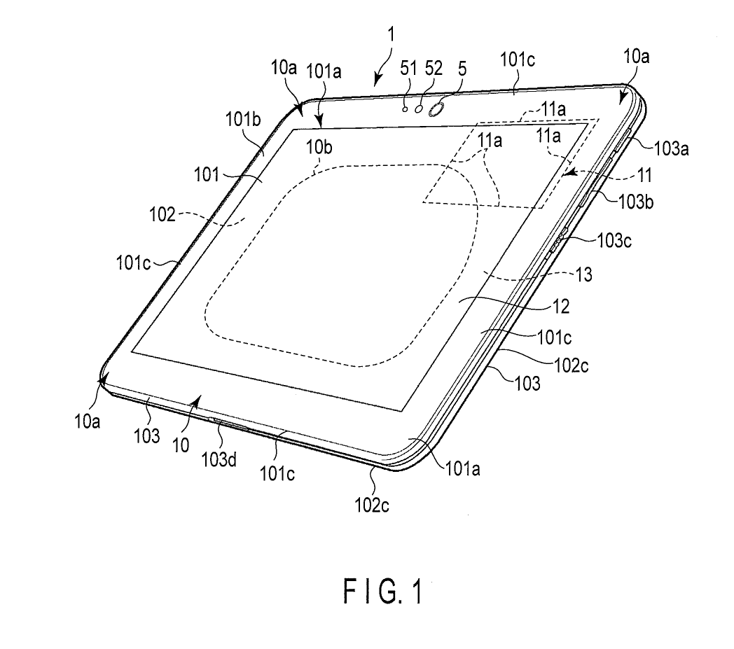

An information processor 1 according to a first embodiment will be described with reference to FIGS. 1 to 4. The information processor 1 shown in FIG. 1 is a so-called tablet type or pad type information processor, and comprises an enclosure 10 and a wireless communication module 11.

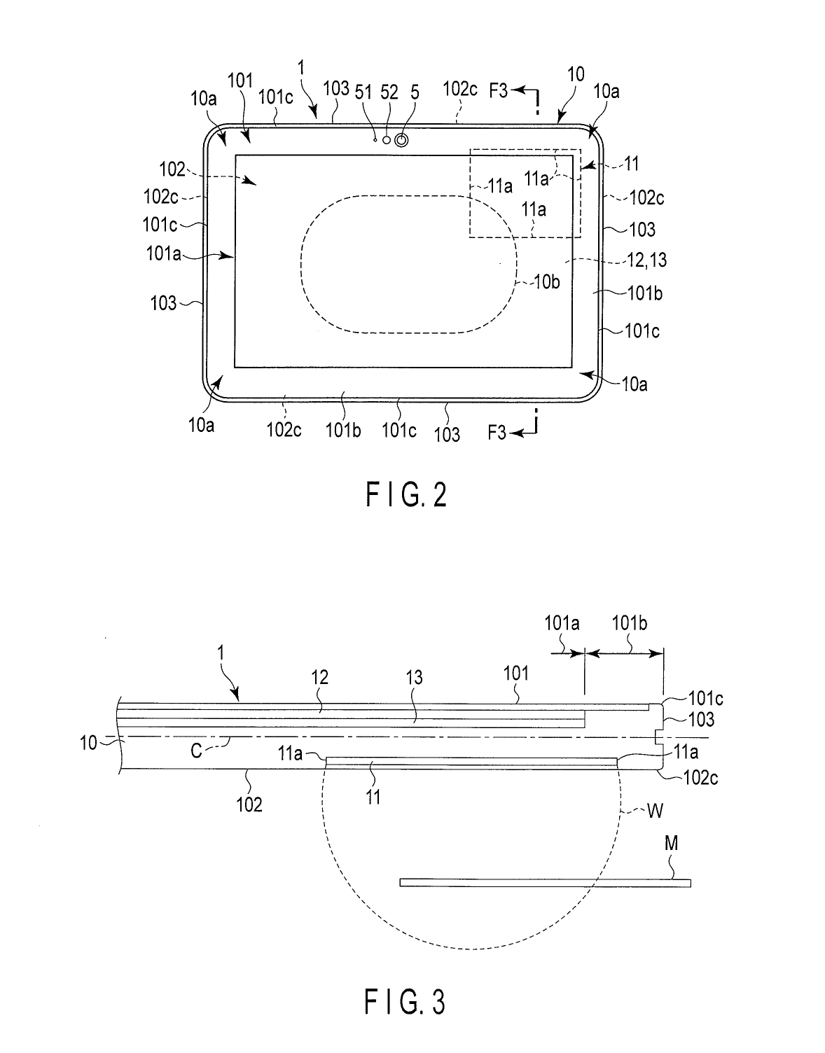

The enclosure 10 has a flat outer shape, and has a first face 101, a second face 102, a third face 103, corner portions 10a and a center portion 10b. In the first embodiment, the first face 101 shown in FIG. 3 is made of a transparent member, and a display device 12 and a touch sensor 13 adjacent to the first face 101 are incorporated in the enclosure 10. As shown in FIG. 2, a range where the touch sensor 13 is arranged, out of the first face 101, is an input region 101a, and a range positioned outside the input region 101a is a surrounding region 101b. The surrounding region 101b is called frame or rim.

The display device 12 and the touch sensor 13 shown in FIG. 3 are cooperative, and the input region 101a on the first face 101 is contacted based on information on graphics or characters displayed on the display device 12 so that the information displayed on the display device 12 can be operated or character information can be input. Thus, the first face 101 functions as an operating unit for input operation.

The information processor 1 further comprises a camera module 5 in the surrounding region 101b corresponding to one of outer peripheries 101c of the first face 101. An indicator 51 indicating that the camera module 5 is being activated, and an illumination sensor 52 used for adjusting luminance of the display 12 and for adjusting exposure of the camera module 5 are arranged near the camera module 5. The camera module 5 is used as a so-called web camera for photographing a user. Thus, as shown in FIGS. 1 and 2, the information processor 1 is used such that the surrounding region 101b where the camera module 5 is arranged in use is positioned at the upper part in a typical case.

As shown in FIG. 3, the second face 102 is positioned opposite to the first face 101. The third face 103 is provided across the outer periphery 101c of the first face 101 and the outer periphery 102c of the second face 102. The information processor 1 shown in FIG. 1 comprises operation buttons such as a power supply switch 103a, a sound adjustment button 103b and a multi-function button 103c, terminals such as a headphone terminal and a connector 103d for connecting to a peripheral device in a wired manner, a speaker, and a socket or slot into which a memory chip such as portable storage medium is to be inserted, to be exposed on the third face 103.

The corner portion 10a is configured of the outer peripheries 101c and 102c of the first face 101 and the second face 102. In the first embodiment, as shown in FIG. 2, for the enclosure 10, the first face 101 and the second face 102 are substantially rectangular, and the corner portions 10a corresponding to the four corners thereof are formed to be rounded. The center portion 10b is slightly inward from the corner portions 10a and the outer periphery 101c along the first face 101 and the second face 102. The center portion 10b houses therein components such as a substrate, a battery and a liquid crystal display “LCD.”

As shown in FIG. 3, the wireless communication module 11 is incorporated in the enclosure 10 adjacent to the second face 102 along the second face 102. In the present embodiment, the wireless communication module 11 is arranged closer to the second face 102 from the center face C in the thickness direction of the enclosure 10 crossing with the first face 101 and the second face 102.

The wireless communication module 11 has at least one side 11a extending between the first face 101 and the second face 102. In the present embodiment, an outer shape of an antenna forms a rectangular region as shown in FIG. 2 and thus the wireless communication module 11 has four sides 11a. The wireless communication module 11 is arranged such that at least part of the side 11a is near the corner portion 10a at a position overlapping with the surrounding region 101b of the first face 101. In the present embodiment, the two sides 11a slightly overlap with the surrounding region 101b, or are arranged near the corner portion 10a at a slight distance from the third face 103 at a constant distance from the outer peripheries 101c and 102c of the first face 101 and the second face 102.

In the information processor 1 shown in FIGS. 1 and 2, the wireless communication module 11 is incorporated near the second face 102 at the upper right part of the enclosure 10 viewed from the user, which is opposite to the first face 101 serving as both the display and the input unit in a normally-used placement of the information processor 1 in which the camera module 5 is positioned at the upper part. The wireless communication module 11 is configured of a control unit and an antenna, and forms a wireless communication region W in the area schematically shown in FIG. 3 toward the second face 102. In this embodiment, the wireless communication module 11 is a near field communication (NFC) module that forms the wireless communication region W in a remarkably close region.

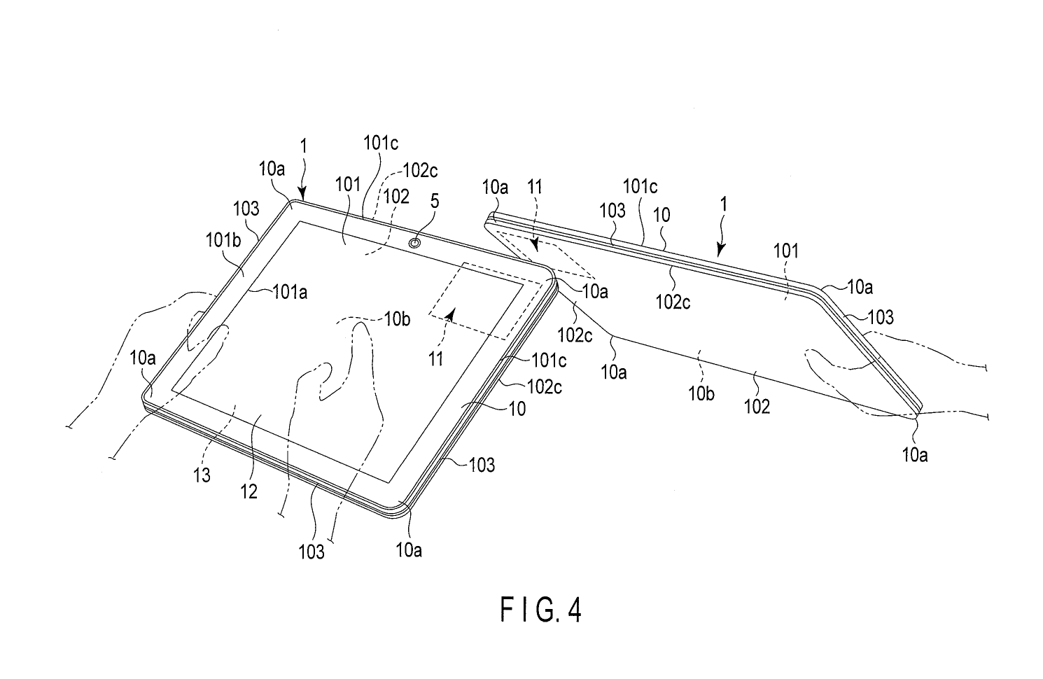

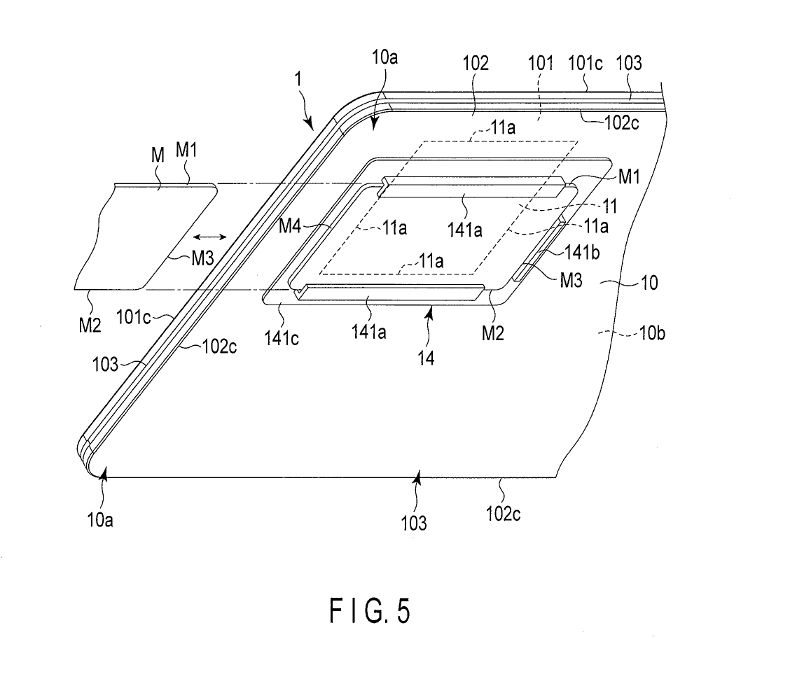

The information processor 1 having the above structure can make communication by use of the wireless communication module 11, not only being used alone. As shown in FIG. 4, the information processors 1 comprising the wireless communication module 11 are closer to a region where their wireless communication regions W overlap with each other, thereby exchanging information.

For each of the information processors 1, the wireless communication module 11 is arranged closer to the second face 102 opposite to the first face 101 for input operation, and the wireless communication region W is formed outside the second face 102. Thus, the user can make wireless communication while operating the information processor 1 as shown in FIG. 4. When data is provided to the party information processor 1 between the information processors 1 mutually connected via the wireless communication modules 11, information may be transmitted to the party information processor 1 via a so-called flick operation as shown in FIG. 4. In this way, with the information processor 1 according to the first embodiment, user convenience for the wireless communication using the wireless communication module 11 is enhanced.

When an information medium M such as a card or tag mounting an IC chip which is activated by a radio wave output from the wireless communication module 11 thereon, or a cell phone is put in the wireless communication region W of the information processor 1 as shown in FIG. 3, information can be read from or written into the information medium M. At this time, the wireless communication module 11 in the information processor 1 forms the wireless communication region W outside the second face 102 opposite to the first face 101 for input operation. That is, since the first face 101 is not covered with the information medium M, the functions of the first face 101 as the display and the input unit do not fail.

When the wireless communication region W is formed at the first face 101 side, the user may contact the first face 101 by placing the information medium M over it. In order to prevent erroneous operations, the working area (usable area) of the display device 12 and the touch sensor 13 may need to be changed between operating and non-operating of the wireless communication module 11.

However, with the information processor 1, the first face 101 is not covered when information is read from or written into the information medium M by the wireless communication module 11. That is, the region where the first face 101 functions as the display and the input unit does not need to be restricted, and thus special control is unnecessary.

For a situation in which the information in the information medium M such as a card incorporating an IC chip therein needs to be read by the wireless communication module 11 mounted on the portable information processor 1, it is assumed that the information medium M is a credit card or personal authentication card and information therein is used to operate the portable information processor 1. In such a situation, one hand is used only for holding the information medium M. It is assumed that continuous information communication is needed for the information medium M or the information processor 1 has to be operated while the information medium M is being held. If one hand is used only for such a situation, the information processor 1 is difficult to operate. Assuming that the user uses the information processor 1 while moving, the information medium M is desirably held in the wireless communication region W in the wireless communication module 11.

There will be described second to twelfth embodiments of the information processor 1 that comprises a holder 14 holding at least part of the information medium M incorporating an IC chip therein within the wireless communication region W formed by the wireless communication module 11. In each embodiment, there will be described, by way of example, a case in which the information medium M is a card-shaped information medium M. The constituents having the same functions as those of the information processor 1 according to the first embodiment are denoted with the same reference numerals as those of the information processor 1 according to the first embodiment, and an explanation thereof will refer to the corresponding description for the first embodiment.

An information processor 1 according to the second embodiment will be described with reference to FIG. 5. A holder 14 in the information processor 1 is arranged such that at least part of it overlaps with a region where a wireless communication module 11 is arranged in a direction perpendicular to a second face 102. The holder 14 includes hooks 141a, a stopper 141b and a base 141c. The hooks 141a and the stopper 141b project out from the second face 102.

The hooks 141a and the stopper 141b are formed by mold injection to be integral with the base 141c adhered to the second face 102 of an enclosure 10. The hooks 141a hold a pair of outer edges M1 and M2, which are parallel opposite sides of a card-shaped information medium M, along the second face 102. When the information medium M is positioned within a wireless communication region W, the stopper 141b is arranged to abut an outer edge M3 which is not distant from a third face 103 as an outer periphery of the enclosure 10, out of the outer edges M3 and M4 crossing with the outer edges M1 and M2.

A dimension between the tip end of the hook 141a and the base 141c in the thickness direction of the information medium M is the same as or slightly smaller than the thickness of the information medium M at part of the full length of the hook 141a. The hook 141a is molded by elastic synthetic resin, and the information medium M is held by a friction force which is obtained by sandwiching the information medium M between the base 141c and the hooks 141a. As it can be easily seen from a first face 101 side of the information processor 1 that the information medium M is attached to the holder 14, the outer edge M4 of the information medium M adjacent to the third face 103 of the enclosure 10 may project out from the third face 103. At this time, the stopper 141b facing the outer edge M3 of the information medium M is formed to be flexible or to easily collapse so as not to break the information medium M even when an external force is applied to the information medium M.

The holder 14 may further comprise a bump that presses the outer edge M4 which is paired with the outer edge M3 contacting with the stopper 141b. The bump is formed as high as the information medium M can pass beyond by its elastic deformation. The holder 14 shown in FIG. 5 is adhered and fixed to the second face 102 in the information processor 1 by the base 141c. The hooks 141a and the stopper 141b may be directly formed on the second face 102 of the enclosure 10. The hooks 141a may be formed to continuously surround the three outer edges M1, M2 and M3 of the information medium M, instead of the stopper 141b.

With the information processor 1 comprising the holder 14 having the above structure according to the second embodiment, the information medium M is attached to the holder 14 so that the user does not need to hold it while reading and writing information from and into the information medium M by the wireless communication module 11. Since the holder 14 is attached to the second face 102, it does not hinder the display on the first face 101 or an input operation from the first face 101. Even when the information medium M is accessed many times, the information medium M does not need to be held over the wireless communication region W of the wireless communication module 11 each time. With the holder 14 provided, it is possible to easily know where the wireless communication region W is formed on the second face 102 of the information processor 1.

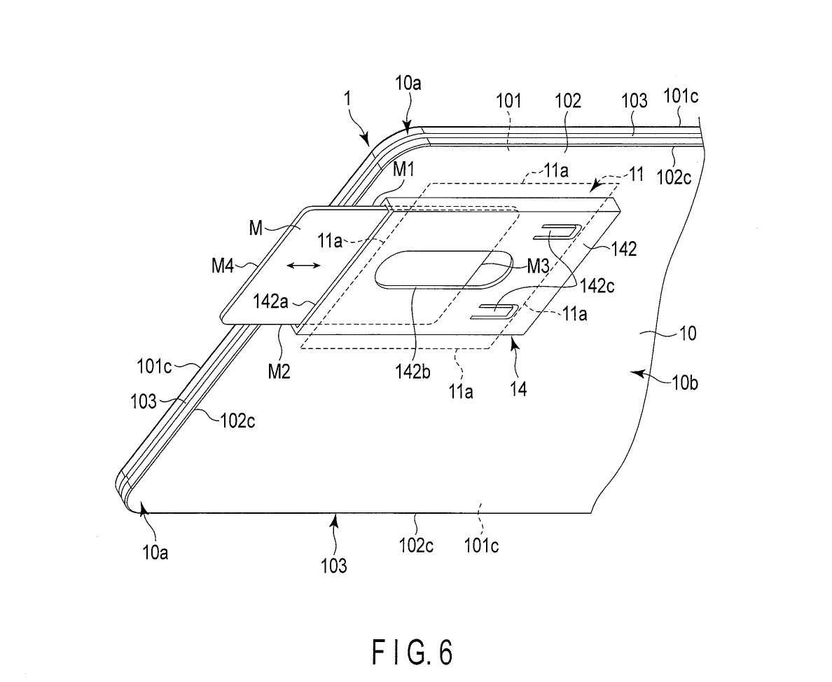

An information processor 1 according to the third embodiment will be described with reference to FIG. 6. A holder 14 in the information processor 1 shown in FIG. 6 is arranged such that at least part of a stored information medium M overlaps with a region where a wireless communication module 11 is arranged in a direction perpendicular to a second face 102. The holder 14 is a case 142 that has a slot 142a through which the information medium M is to be inserted along the second face 102 from a third face 103 as an outer periphery of the information processor 1 at a position facing the third face 103 of the enclosure 10 as an outer periphery of the information processor 1.

In the third embodiment, the case 142 is sized to completely house the information medium M. The case 142 has a window 142b through which part of the stored information medium M can be seen. The window 142b may be sealed by a transparent member or may be hollowed out as shown in FIG. 6.

In the third embodiment, the hollowed-out window 142b is large enough to contact part of the stored information medium M, and has a length in a direction substantially perpendicular to the slot 142a. Thus, the user can put his/her finger into the window 142b and directly draw the information medium M stored in the case 142. That is, in the third embodiment, the window 142b functions as an opening through which at least part of the information medium M stored in the case 142 can be touched.

The case 142 has a lever 142c as a holding mechanism for holding the stored information medium M to be distant from the slot 142a. The information medium M is held inside the case 142 by a friction force caused by a friction between the tip end of the lever 142c and the outer surface of the information medium M. In FIG. 6, the lever 142c is configured to press the information medium M in the thickness direction of the information medium M. The lever 142c may be configured to contact the information medium M in a width direction crossing with a direction in which the information medium M is inserted into the case 142.

When the case 142 is made of transparent hard resin, a design on the information medium M can be seen well, which enables to easily determine which is the stored information medium M. The entire case 142 does not necessarily need to be transparent. An area where part of the information medium M is seen may be transparent if only the information medium M stored in the case 142 is discriminable.

The holder 14 may be a pocket sewed in a bag shape by a thin film or sheet, instead of a hard body having a certain thickness like the case 142 shown in FIG. 6. The holder is foldable while the information medium M is not stored therein, which is not troublesome. The holder 14 may not store the entire information medium M, unlike FIG. 6. For example, the case 142 may be formed to house half the information medium. When the case 142 is formed such that the information medium M is protruded, the case 142 may be attached to easily drop when more than a certain external force is applied to the information medium M, in order to prevent the information medium M from being unintentionally hooked and broken.

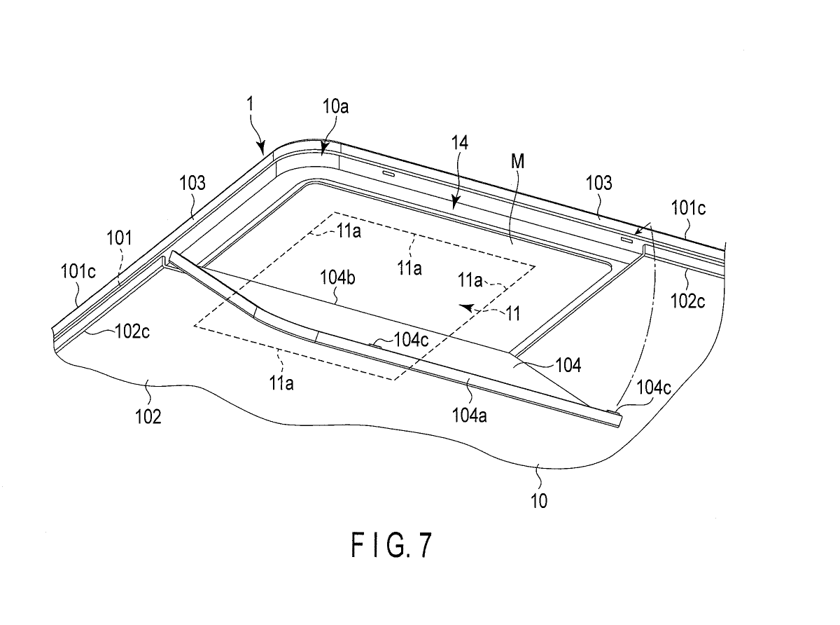

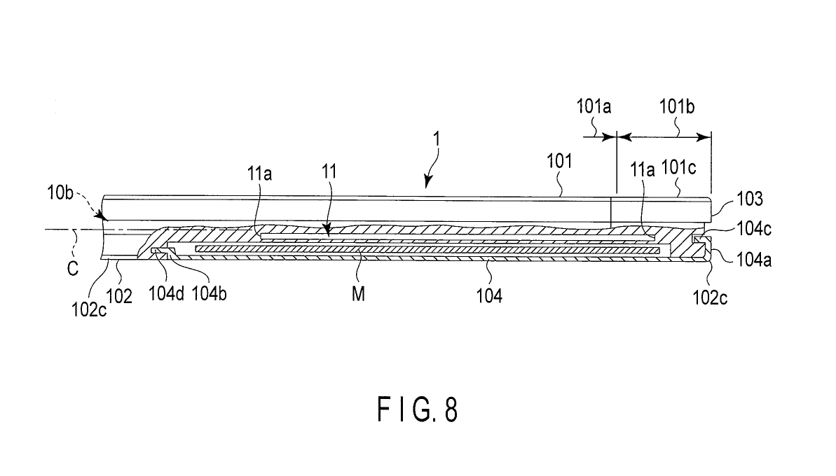

An information processor 1 according to the fourth embodiment will be described with reference to FIGS. 7 and 8. As shown in FIG. 8, the information processor 1 has a wireless communication module 11 at a position closer to a second face 102 from the center face C of a enclosure 10, and a holder 14 is formed inside the enclosure 10 between the wireless communication module 11 and the second face 102. The information processor 1 has a hatch 104 on an outer envelope configuring the second face 102 corresponding to a region where the wireless communication muddle 11 is arranged. As shown in FIG. 7, the hatch 104 is provided in a region including a corner portion 10a of the enclosure 10, is configured of two outer peripheries 102c of the second face 102 as outer peripheries of the enclosure 10 configuring the corner portion 10a, the second face 102 continuous thereto, and two third faces 103, and rotates to open in a direction crossing with the second face 102.

As shown in FIG. 8, the hatch 104 has engagement claws 104c and 104d extending in the same direction in an open outer edge 104a and an inner edge 104b at the rotation base end side. When the hatch 104 is slid in the direction in which the engagement claws 104c and 104d extend, the hatch 104 is disengaged from the enclosure 10. Consequently, as shown in FIG. 7, when the hatch 104 is rotated about the inner edge 104b, a card-shaped information medium M can be put into and out from the holder 14.

Since the wireless communication module 11 permits wireless communicating, the hatch 104 is made of a non-conductive member such as synthetic resin. When a sufficient space for the holder 14 cannot be secured inside the enclosure 10, a space for holder 14 may be provided inside the hatch 104 and may be replaced with a hatch projecting out of the second face 102.

When the engagement claw 104d provided on the inner edge 104b is formed to be longer than the engagement claw 104c on the outer edge 104a, it functions as a fulcrum for opening and closing the hatch 104 and thus is easily operable. The hatch 104 may be coupled to the enclosure 10 via a flexible member. The hatch 104 may be fixed by other means instead of the engagement claws 104c and 104d shown in FIGS. 7 and 8 in order to maintain the hatch 104 closed. In order to confirm whether the information medium M is stored in the holder 14, a window 142b may be provided in the hatch 104 or a sensor or microswitch for detecting that the information medium M has been stored may be installed at the back of the holder 14.

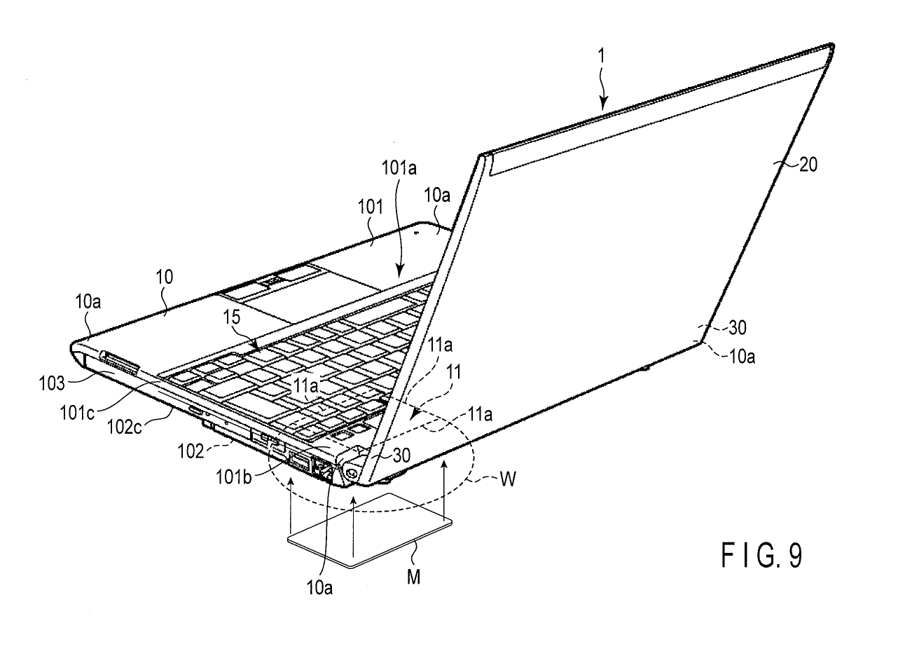

An information processor 1 according to the fifth embodiment will be described with reference to FIGS. 9 to 11. The information processor 1 shown in FIG. 9 is a so-called clamshell type or notebook type information processor, and comprises an enclosure 10, a display 20, a hinge 30 and a wireless communication module 11. The enclosure 10 has a keyboard 15 as an operation unit for input operation on a first face 101. In the fifth embodiment, the first face 101 in a region where the keyboard 15 and the like are provided is an input region 101a, and the first face 101 around the input region is a surrounding region 101b. The display 20 is coupled to the enclosure 10 via the hinge 30, and comprises a display device 12 for displaying information such as graphics and characters for the first face 101 in the enclosure 10.

The wireless communication module 11 is incorporated inside the enclosure 10 to form a wireless communication region W outside a second face 102 arranged in substantially parallel with the first face 101. In the information processor 1 according to the fifth embodiment, the wireless communication module 11 is arranged inside the enclosure 10 at the right back viewed from the user using the information processor 1, or inside the enclosure 10 near the part coupled via the hinge 30. Thus, the wireless communication region W is formed not only in a direction perpendicular to the second face 102 as shown in FIG. 9 but also in a direction farther from the enclosure 10 along the second face 102.

The information processor 1 having the above structure may be used alone or may communicate with other information processor 1 comprising a wireless communication module, or an electronic device by use of the wireless communication module 11. For example, the wireless communication module 11 in the information processor 1 shown in FIG. 9 is arranged to face a wireless communication module in other information processor such that the mutual wireless communication regions W overlap with each other. When the wireless communication regions W overlap with each other, communication can be continuously made.

The wireless communication region W formed by the wireless communication module 11 is formed at the second face 102 opposite to the first face 101 for input operation, and opposite to the display face of the display 20. That is, when the wireless communication module 11 is to be used, a communication party's apparatus arranged within the wireless communication region W does not hinder input operation and display in order to maintain the communication state of the wireless communication module 11.

The information processor 1 may mount other wireless communication means thereon. In such a case, a key code or access authentication code for encrypting and decrypting communication used for wireless communication with a device to be connected can be exchanged by the wireless communication module 11, much more information can be exchanged by other wireless communication means, or information can be exchanged between mutually-separated points.

The information medium M mounting an IC chip thereon is placed in a region where the wireless communication region W is formed similarly as in the first to fourth embodiments, information can be read from or written into the information medium M. The clamshell type information processor 1 shown in FIG. 9 is assumed to be used on a desk or knees.

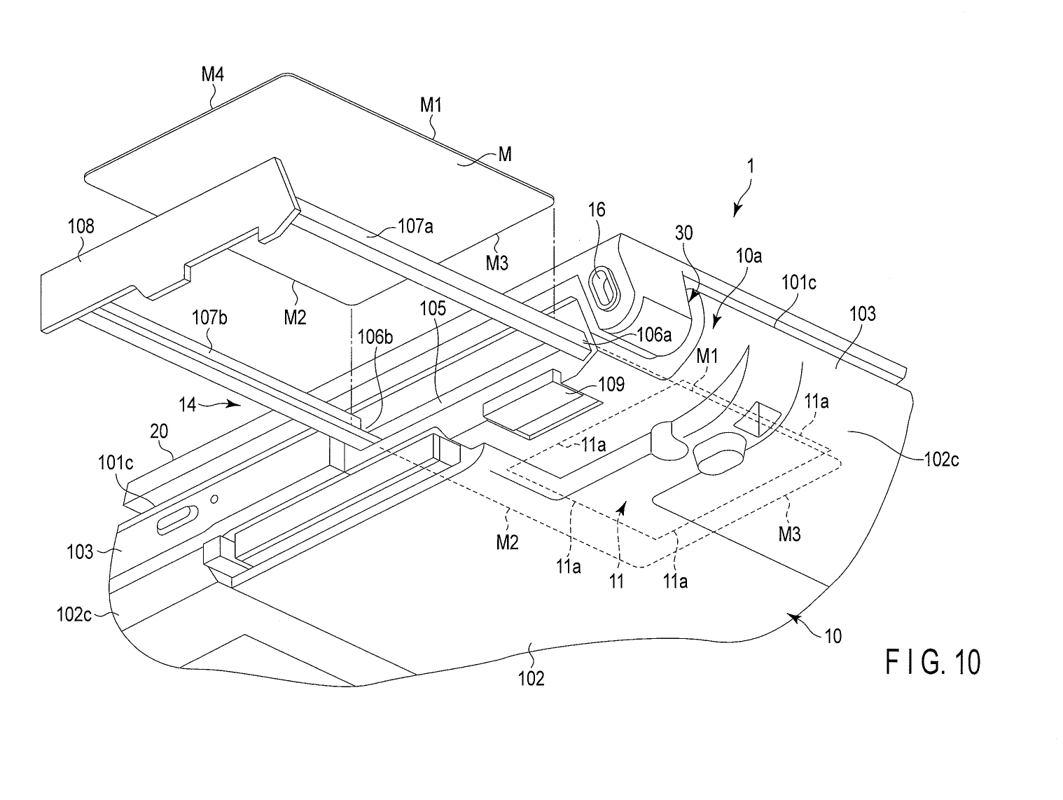

In such a case, the information processor 1 according to the fifth embodiment comprises a holder 14 storing the information medium M therein in the enclosure 10 as shown in FIG. 10 such that the information medium M does not need to be arranged in the wireless communication region W each time. The holder 14 includes a slot 105 which is formed inside the enclosure 10 along the second face 102 from the outer periphery of the first face 101 and through which the card-shaped information medium M is inserted. The slot 105 is formed along the second face 102 between the wireless communication module 11 and the second face 102.

As shown in FIG. 10, the holder 14 includes guides 106a, 106b, rods 107a, 107b, a cover 108 and an ejector 109. The guides 106a and 106b are arranged at both ends of the slot 105 in the width direction, and guides the rods 107a and 107b in a direction in which the information medium M is inserted. The rods 107a and 107b support outer edges M1 and M2 of the information medium M along the insertion direction. The cover 108 couples the tip ends of the rods 107a and 107b, and closes the slot 105 when the rods 107a and 107b are drawn into the guides 106a and 106b.

When being pushed into the inside of the enclosure 10, the ejector 109 relatively pushes the rods 107a and 107 to the outside of the enclosure 10. The mechanism of the ejector 109 is configured of a lever or spring incorporated between the rods 107a, 107b and the ejector 109. A grasping mechanism for holding the information medium M in the slot 105 may be provided at the back of the slot 105 instead of providing the ejector 109. The grasping mechanism includes a latch structure for grasping the information medium M inserted into the slot 105 up to a certain position and projecting at least part of the information medium M to the outside of the slot 105 when the information medium is pushed into the slot 105 beyond a certain position.

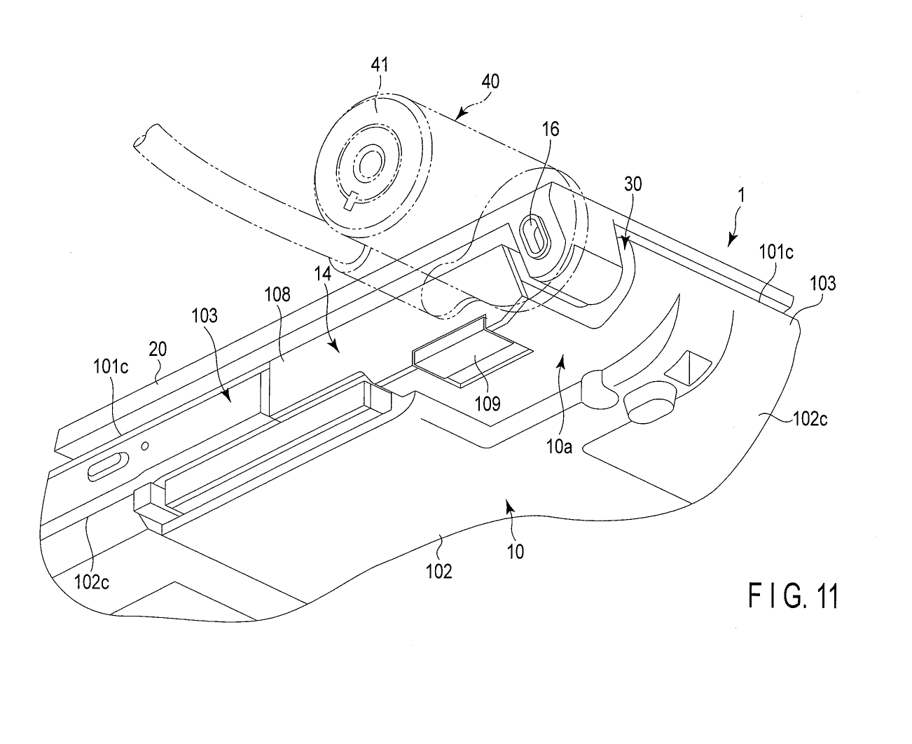

In the information processor 1 according to the fifth embodiment having the above structure, the information medium M is placed on the rods 107a and 107b drawn from the enclosure 10 as shown in FIG. 10 in order to mount the information medium M in the holder 14. When the rods 107a and 107b are pushed into the enclosure 10, the information medium M is also inserted into the slot 105. Then, the slot 105 is covered with the cover 108 as shown in FIG. 11.

The information in the information medium M stored in the holder 14 may be read or rewritten by the wireless communication module 11. When the information medium M stored in the holder 14 is taken out, the ejector 109 is pushed. The rods 107a and 107b are slightly pushed out of the enclosure and then a finger may be hooked on the cover 108 to draw the rods 107a and 017b together with the information medium M.

The information processor 1 according to the fifth embodiment stores the information medium M in the holder 14 provided inside the enclosure 10, and thus the mounted information medium M is not noticeable and looks nice. Since the slot 105 is covered with the cover 108, even if the information processor 1 with the information medium M inserted into the holder 14 is carried, the information medium M do not drop unintentionally.

In the fifth embodiment, the information processor 1 has a mooring hole 16 for coupling a security cable 40 adjacent to the slot 105 in the holder 14 as shown in FIGS. 10 and 11. In FIGS. 10 and 11, the mooring hole 16 is provided in the display 20 positioned on a rotation axis of the hinge 30 coupling the enclosure 10 and the display 20. When the hinge 30 is not near the slot 105, for example when it is provided closer to the center of the enclosure 10, the mooring hole 16 is arranged in the enclosure 10 adjacent to the slot 105.

The security cable 40 has a robust head 41 which is released by a key. When being connected to the mooring hole 16, the head 41 of the security cable 40 at least partially interferes with a trajectory for taking out the information medium M from the holder 14. When the holder 14 comprises the cover 108 as in the fifth embodiment, the mooring hole 16 is arranged such that at least the head 41 of the security cable 40 interferes with a trajectory for opening the cover 108. When the mooring hole 16 is prepared in the display 20 as in the fifth embodiment, if the head 41 of the security cable 40 is always positioned on the trajectory for taking out the information medium M from the holder 14 even when the display 20 is rotated relative to the enclosure 10, the mooring hole 16 does not necessarily need to be arranged on the rotation axis of the hinge 30.

Even if the user is away from the information processor 1 while using the information processor 1 with the information medium M including important information therein, such as credit card or personal authentication card, in the holder 14, the security cable 40 is connected to the information processor 1 and thus the information processor 1 can be prevented from being stolen together with the information medium M. Since the head 41 of the security cable 40 interferes with a trajectory for taking out the information medium M from the slot 105, thereby preventing only the information medium M from being stolen.

In order to promote the user to connect the security cable 40 when the information medium M is stored in the holder 14, sensors such as microswitches are arranged at the back of the slot 105 and in the mooring hole 16, respectively. When the sensor of the slot 105 detects that the information medium M is stored in the holder 14 and when the sensor of the mooring hole 16 detects that the security cable 40 is not connected to the mooring hole 16, an alarm is displayed on the display 20 in the information processor 1 or an alarm is issued from the enclosure 10.

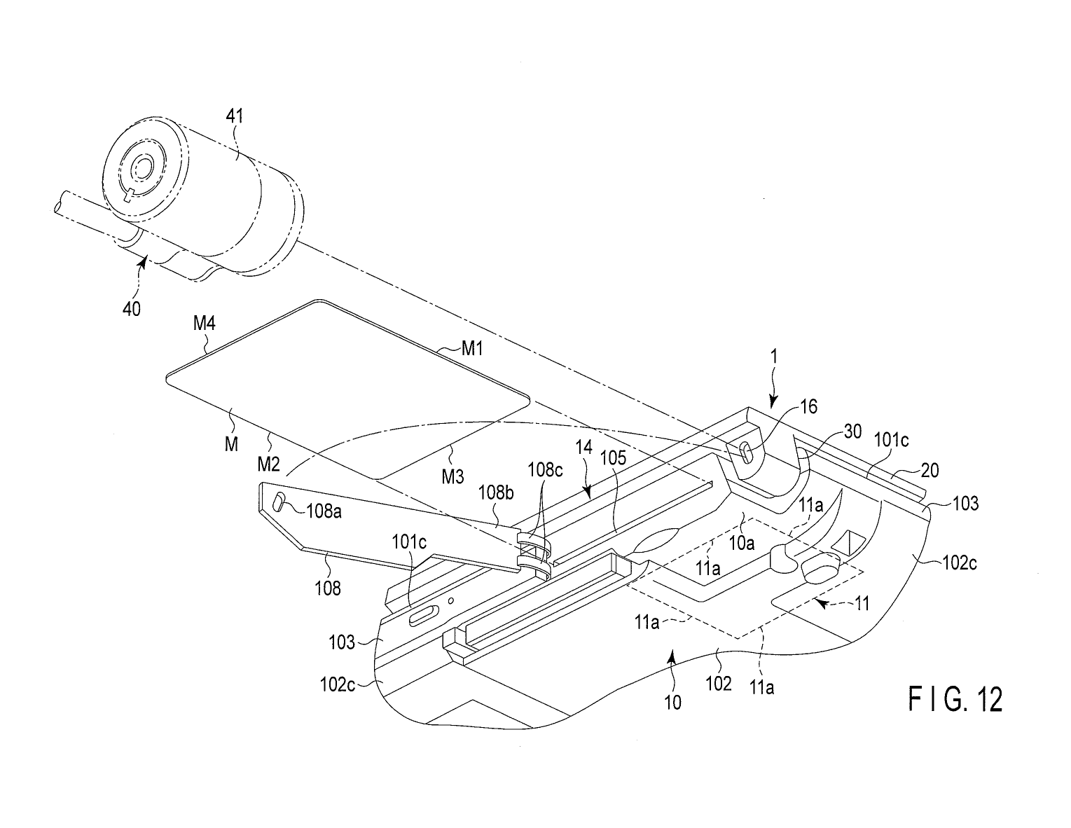

An information processor 1 according to the sixth embodiment will be described with reference to FIG. 12. The information processor 1 is of the same clamshell type as that according to the fifth embodiment. FIG. 12 shows the information processor 1 in a region where a wireless communication module 11 is arranged. The information processor 1 is simpler than the information processor 1 according to the fifth embodiment in the structure of a holder 14. As shown in FIG. 12, the holder 14 includes a slot 105 opened to an outer periphery of the enclosure 10 and a cover 108 covering the slot 105. The slot 105 is positioned between the wireless communication module 11 and a second face 102, and an information medium M is arranged such that at least part of the information medium M is within a wireless communication region W formed by the wireless communication module 11.

The cover 108 is large enough to cover not only the slot 105 but also a mooring hole 16, and has a lock-hole 108a to be overlapped with the mooring hole 16. An end 108b of the cover 108 opposite to the side where the lock-hole 108a is provided away from the slot 105 is coupled to the enclosure 10 via a flexible belt 108c. As shown in FIG. 12, the belt 108c is long enough to move the cover 108 to a position which does not interfere with a trajectory for inserting or taking out the information medium M into or from the slot 105 of the holder 14 when the cover 108 is opened, and is fitted with the enclosure 10. When the cover 108 is closed, the belt 108c is inserted into the enclosure 10. An end of the cover 108 at a side where the lock-hole 108a is provided is engaged with any portion around the slot 105.

The lock-hole 108a overlaps with the mooring-hole 16 provided in the enclosure 10 while the cover 108 is being closed. Thus, in the information processor 1 according to the sixth embodiment, a head 41 of a security cable 40 is attached to the mooring hole 16 through the lock-hole 108a. The head 41 is attached so that the cover 108 cannot be easily opened.

In FIG. 12, the mooring hole 16 is provided at the display 20 side in the hinge 30 coupling the enclosure 10 and the display 20. The mooring hole 16 does not need to be provided at the display 20 side. With a different structure of the hinge 30, if the head 41 of the security cable 40 can be arranged to interfere with a trajectory for taking out the information medium M from the holder 14, the mooring hole 16 may be provided on the enclosure 10 side.

The information processor 1 according to the sixth embodiment having the above structure comprises the wireless communication module 11 that forms the wireless communication region W to the outside of the second face 102 opposite to the first face 101 for input operation of the enclosure 10. Thus, the information processor 1 can make wireless communication with other information processor or electronic device, or the information medium M mounting an IC chip thereon, without hindrance of input operation. The information processor 1 has the holder 14 for storing the information medium M therein in the enclosure 10. When the information is read from or rewritten into the information medium M, a burden of placing the information medium M over the wireless communication region W formed by the wireless communication module 11 is improved.

The mooring hole 16 is provided such that the head 41 of the security cable 40 is positioned at a position interfering with the trajectory for taking out the information medium M from the holder 14. The cover 108 has a lock-hole 108a at the end overlapping with the mooring hole 16. The security cable 40 is attached to the information processor 1, thereby preventing the information medium M stored in the holder 14 from being stolen.

In the information processor 1 according to the sixth embodiment, the cover 108 is coupled to the enclosure 10 to rotate along the first face 101 or the second face 102. The cover 108 has only to travel to a position not interfering with the trajectory for inserting or taking out the information medium M into or from the slot 105 of the holder 14, and thus the belt 108c for coupling the cover 108 to the enclosure 10 may be provided at a position other than the position shown in FIG. 12. For example, the cover 108 may be coupled to the enclosure 10 such that the cover 108 rotates toward the first face 101 or the cover 108 rotates toward the second face 102.

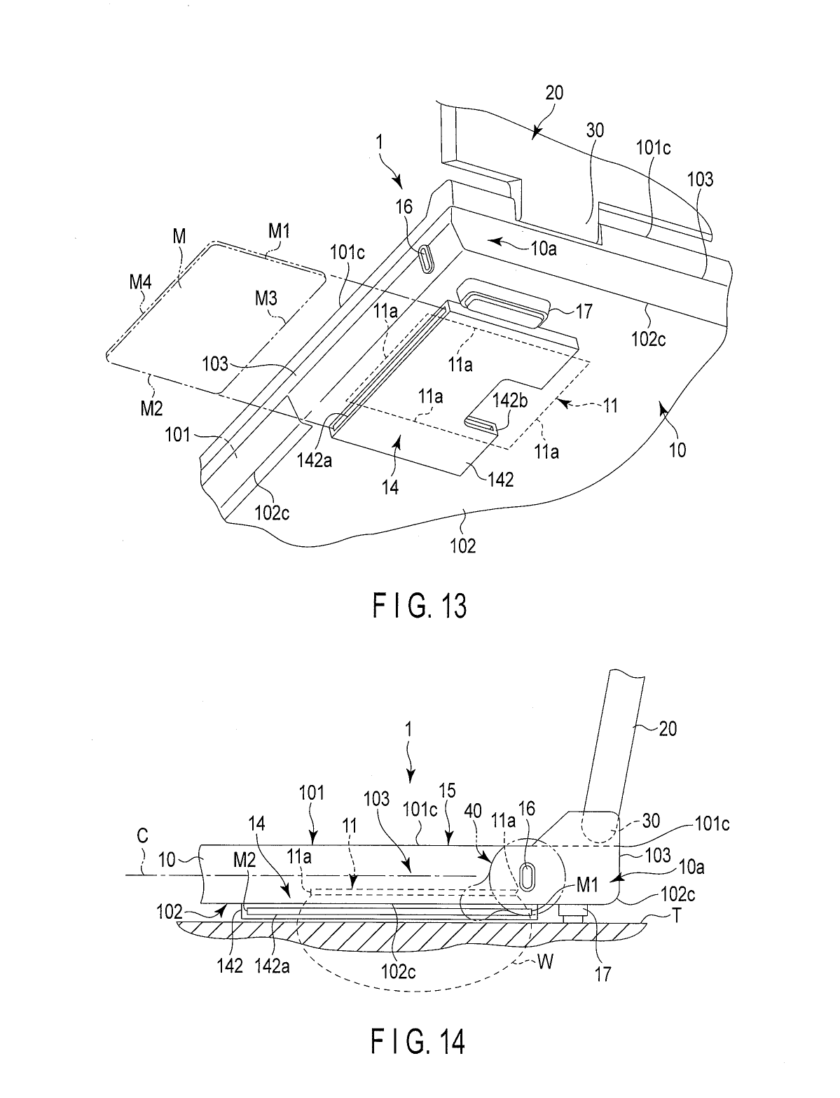

An information processor 1 according to the seventh embodiment will be described with reference to FIGS. 13 and 14. The information processor 1 shown in FIG. 13 is of the same clamshell type as the information processor according to the fifth and sixth embodiments. FIG. 13 is a perspective view in which the information processor 1 in a region where a wireless communication module 11 forming a wireless communication region W outside a second face 102 of a enclosure 10 is arranged is viewed from the second face 102 side.

The information processor 1 comprises a case 142 of the same type as the case 142 employed as the holder 14 in the information processor 1 according to the third embodiment, as a holder 14 as shown in FIG. 13. The wireless communication module 11 is arranged closer to the second face 102 in the enclosure 10 as shown in FIG. 14. The case 142 is arranged such that at least part of a stored information medium M overlaps with a region where the wireless communication module 11 is arranged in a direction perpendicular to the second face 102. As shown in FIG. 14, a mooring hole 16 is provided near the case 142 such that a security cable 40 is attached to a position interfering with a trajectory for taking out the information medium M from the holder 14.

When the information processor 1 is placed on a flat table T such as desk as shown in FIG. 14, the case 142 is held to be separated from the table T by legs 17 supporting the enclosure 10. A slot 142a of the case 142 is formed in a size in which the long side of the card-shaped rectangular information medium M can be inserted. The case 142 according to the seventh embodiment is different from the case 142 according to the third embodiment in that a window 142b as an opening is provided at a middle part of the back in the insertion direction of the information medium M as shown in FIG. 13.

The information medium M stored in the case 142 is held within the case 142 by a holding mechanism. The holding mechanism may be the same lever 142c as that according to the third embodiment, or may be other method. For example, the center part of the slot 142a of the case 142 is formed to be slightly narrower than the information medium M in the thickness direction of the information medium M, and the information medium M is held by a friction between the inner face of the slot 142a and the outer face of the information medium M.

When the information medium M is taken out from the case 142, the information medium M exposed on the window 142b is pushed toward the inlet of the slot 142a by a finger. When a head 41 of the security cable 40 is attached to the mooring hole 16 while the information medium M is being stored in the case 142, the head 41 is arranged on the trajectory for taking out the information medium M, thereby preventing the information medium M from being pulled out.

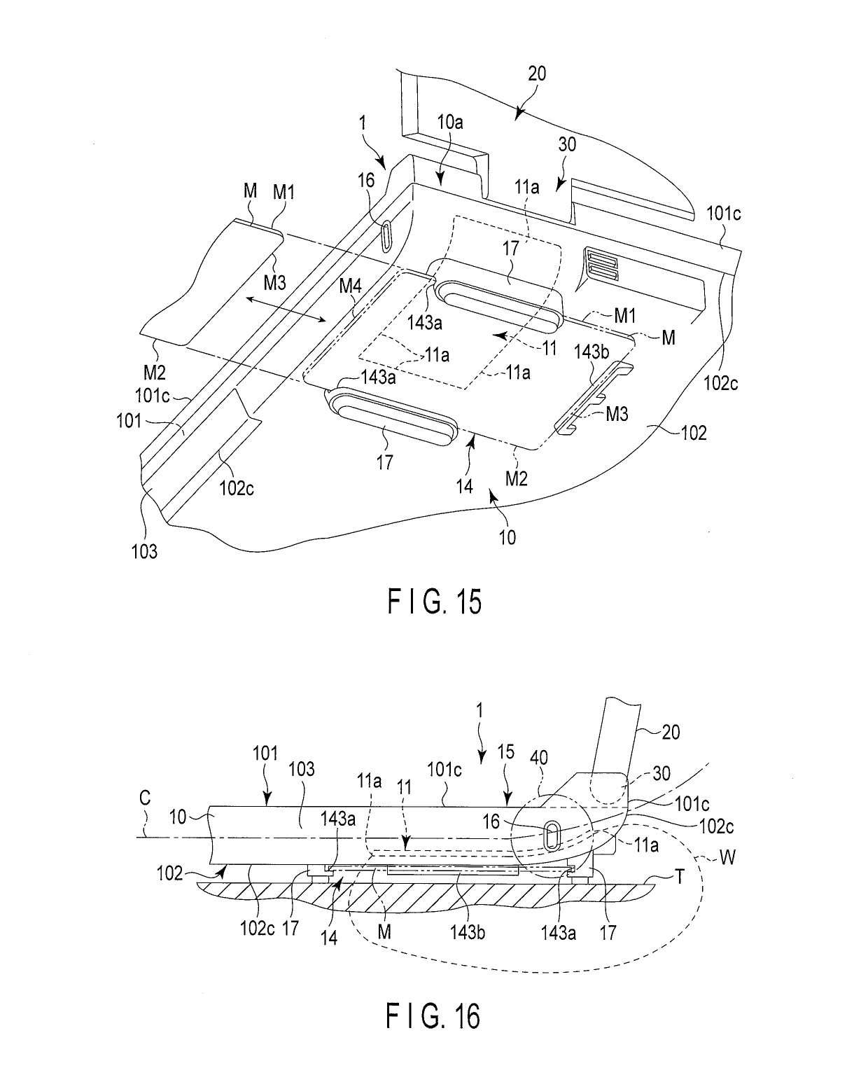

An information processor 1 according to the eighth embodiment will be described with reference to FIGS. 15 and 16. The information processor 1 shown in FIGS. 15 and 16 is of the same clamshell type as the information processor 1 according to the seventh embodiment. FIG. 15 is a perspective view in which the information processor 1 in a region where a wireless communication module 11 is incorporated is viewed from a second face 102 side. For a enclosure 10 of the information processor 1, as shown in FIGS. 15 and 16, an outer periphery 102c as the edge of the second face 102 coupled with a hinge 30 is gently curved toward a first face 101, and is continuous up to a portion corresponding to a third face 103 as an outer periphery connecting the first face 101 and the second face 102. That is, as shown in FIG. 16, in the eighth embodiment, the second face 102 is gently formed to a position where the outer periphery 102c of the second face 102 at the hinge 30 side is adjacent to the outer periphery 101c of the first face 101, and thus the third face 103 at the hinge side 30 is not present.

The wireless communication module 11 is arranged inside the enclosure 10 closer to the second face 102 from the center face C of the enclosure 10 along the second face 102 such that part of the wireless communication module 11 reaches the curved part as shown in FIG. 16. The wireless communication module 11 arranged in this way forms a wireless communication region W from the outside of the second face 102 distant from the hinge 30 toward the outside of the second face 102 forming a portion corresponding to the outer periphery of the enclosure 10 at the side where the enclosure 10 and the display 20 are coupled via the hinge 30. Thus, the wireless communication region W formed by the information processor 1 according to the eighth embodiment is slightly larger to spread toward and over the hinge 30 as shown in FIG. 11 than the wireless communication region W formed by the information processor 1 according to the seventh embodiment.

The information processor 1 according to the eighth embodiment has a plurality of legs 17 attached to the second face 102. At least two legs 17 of the legs extend in substantially parallel to the rotation axis of the hinge 30, and are arranged at the positions sandwiching part of the wireless communication region W formed by the wireless communication module 11. In this embodiment, the holder 14 is provided between the legs 17 extending in parallel. The holder 14 includes support grooves 143a and a stopper 143b.

The support grooves 143a are formed at a side of each of the legs 17, respectively, and oppose each other. A dimension between the legs 17 for which the support groves 143a are formed is narrower than the width dimension between the parallel outer edges M1 and M2 of a card-shaped information medium M, and a dimension between the support grooves 143a is slightly wider than the width dimension of the information medium M. When the information medium M is inserted along the support grooves 143a and is positioned within the wireless communication region W, the stopper 143b is arranged to abut the outer edge M3 of the information medium M farther from the outer periphery of the enclosure 10.

In the information processor 1 according to the eighth embodiment having the above structure, the holder 14 is provided outside the enclosure 10 from the second face 102, and is configured of the support grooves 143a formed on the sides of the legs 17 and the stopper 143b attached to the second face 102 separated from the outer periphery of the enclosure 10.

Thus, as shown in FIG. 15, the provided holder 14 is not conspicuous in terms of its appearance. The fact is suitable for a case where the operation of reading or rewriting information from or into the information medium M is not daily performed by use of the wireless communication module 11 of the information processor 1. As shown in FIG. 16, the mooring hole 16 is provided such that a head 41 of a security cable 40 is arranged at a position interfering with a trajectory for taking out the information medium M from the holder 14. The information medium M can be prevented from being taken out from the holder 14.

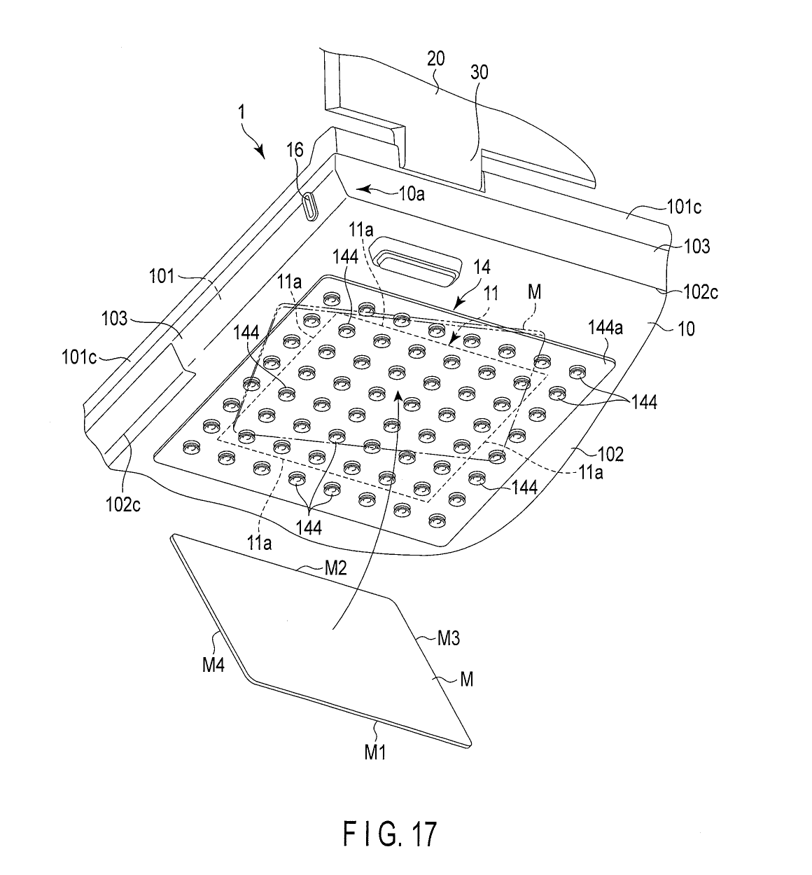

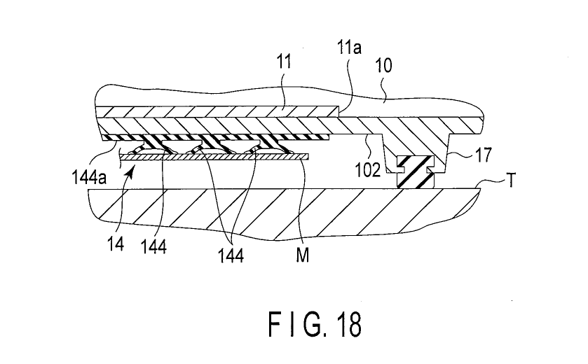

An information processor 1 according to the ninth embodiment will be described with reference to FIGS. 17 and 18. The information processor 1 shown in FIGS. 17 and 18 is of the same clamshell type as that according to the seventh and eighth embodiments. The information processor 1 has a plurality of suckers 144 as a holder 14 on a second face 102 covering a part where a wireless communication module 11 is arranged as shown in FIG. 17. In the ninth embodiment, the suckers 144 are formed to be integral with a base 144a as shown in FIG. 17, and are arranged in a matrix of 8 rows by 8 columns.

In the information processor 1, a card-shaped information medium M mounting an IC chip thereon is pressed to a part where the suckers 144 are arranged as shown in FIG. 17, thereby easily holding the information medium M within the wireless communication region W of the wireless communication module 11 as shown in FIG. 18. When the information medium M is to be removed, it may be released from the suckers 144 against a suction force. A material of the suckers 144 employs a material which is flexible and excellent in durability, such as silicon or urethane.

In the hook 141a of the holder 14 according to the second embodiment, the slot 142a of the holder 14 according to the third and seventh embodiments, the holder 14 according to the fourth embodiment, the slot 105 of the holder 14 according to the fifth and sixth embodiments, and the support grooves 143a of the holder 14 according to the seventh embodiment, the position or orientation of the information medium M needs to be adapted thereto. To the contrary, a holder 14 according to the ninth embodiment is configured of the suckers 144. That is, since the information medium M is only pushed to be held in the holder 14, the positioning of the information medium M is unnecessary. Since the holder 14 is installed on the second face 102 opposite to a first face 101 for input operation, the information processor 1 according to the ninth embodiment in which the user can mount the information medium M without visual confirmation is excellent in operability in this point. When the information mediums S are sequentially replaced to operate the information processor 1, the work of attaching or detaching the information medium M is simple and thus convenient for the user.

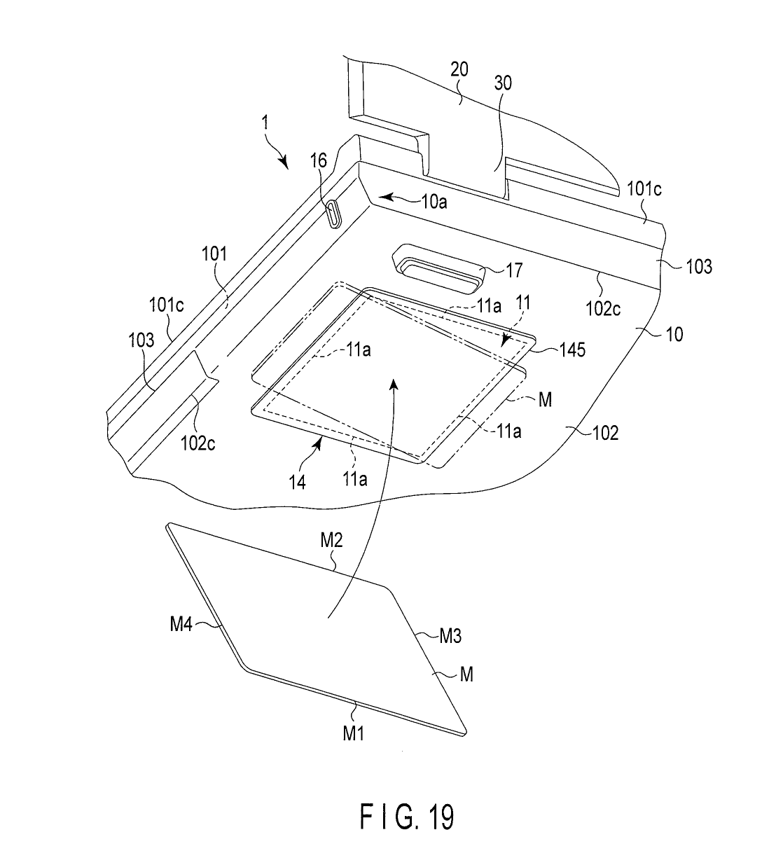

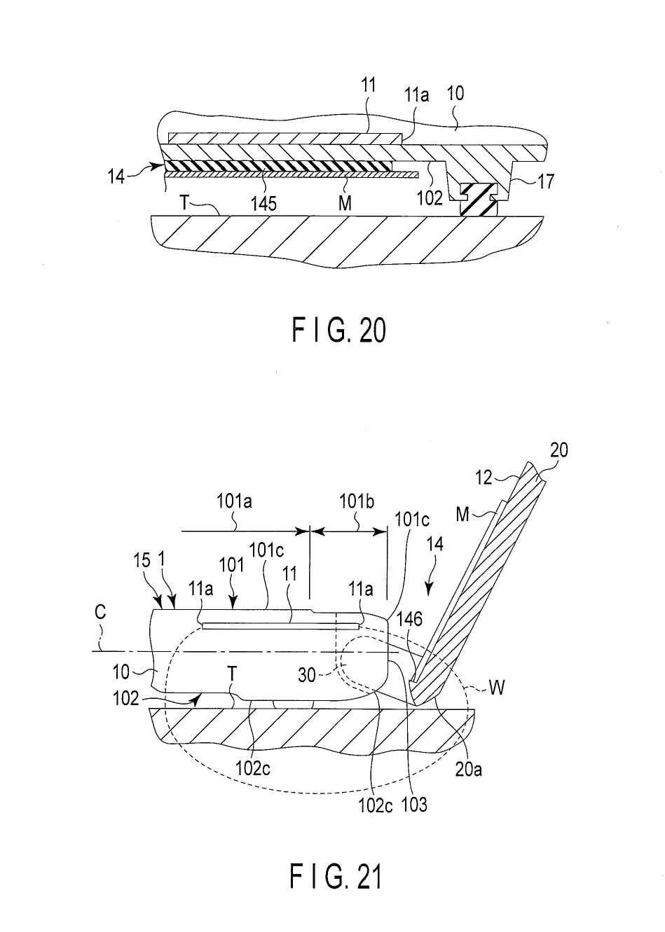

An information processor 1 according to the tenth embodiment will be described with reference to FIGS. 19 and 20. The information processor 1 shown in FIGS. 19 and 20 is of the same clamshell type as that according to the ninth embodiment. The information processor 1 has an adhesion member 145 functioning as a holder 14 on a second face 102 in a region covering a part where a wireless communication module 11 is arranged as shown in FIG. 19.

In the information processor 1, a card-shaped information medium M mounting an IC chip thereon is pressed to the adhesion member 145 as shown in FIG. 19 so that the information medium M can be easily held within the wireless communication region W of the wireless communication module 11 as shown in FIG. 20. When the information medium M is to be removed, the information medium M has only to be released from the adhesion member 145 against an adhesion force. The adhesion member 145 employs synthetic resin or gel which does not pass a adhesive material to the adhered information medium M. The adhesion member 145 is preferably capable of recovering its adhesion force by washing adhered dusts with water.

The information processor 1 according to the tenth embodiment can mount the information medium M on the holder 14 without visual confirmation similarly as in the information processor 1 according to the ninth embodiment. Thus, when the information is read from or rewritten into the information medium M by the information processor 1, the information processor 1 according to the tenth embodiment is excellent in its operability similarly as in the ninth embodiment because the information medium M is temporarily held.

The holder 14 configured of the suckers 144 according to the ninth embodiment and the holder configured of the adhesion member 145 according to the tenth embodiment may be employed as the holder 14 of the tablet type information processor 1 instead of the holder 14 according to the second and third embodiment.

An information processor 1 according to the eleventh embodiment will be described with reference to FIG. 21. The information processor 1 shown in FIG. 21 is of the same clamshell type as that according to the ninth and tenth embodiments. The information processor 1 includes a enclosure 10, a display 20, a hinge 30, a wireless communication module 11 and a holder 14. The enclosure 10 has a rotation shaft of the hinge 30 between a first face 101 and a second face 102. The display 20 is coupled to the rotation shaft of the hinge 30 at a position offset toward the display face side. Thus, when the display 20 is rotated about the rotation shaft of the hinge 30 relative to the enclosure 10 at an angle of 90° or more, an edge 20a of the display 20 coupled to the hinge 30 moves to a position covering a third face 103 as an edge of the enclosure 10 coupled to the hinge 30. The wireless communication module 11 is arranged inside the enclosure 10 closer to the first face 101 from the center face C of the enclosure 10, and forms a wireless communication region W toward the second face 102 opposite to the first face 101.

The holder 14 includes a surface of the display 20 facing the enclosure 10, and a hook protrusion 146 protruding from the surface of the display 20 formed at the end of the display 20 closer to the hinge 30. When the enclosure 10 is placed on a flat table T such as desk and the display 20 is held to be opened about the hinge 30 at an angle of 90° or more while it overlaps with the enclosure 10 to be closed, the holder 14 supports an information medium M. In the state, part of the information medium M enters the wireless communication region W formed by the wireless communication module 11 as shown in FIG. 21.

With the information processor 1 according to the eleventh embodiment, the information medium M set in the holder 14 is supported on the display face side of the display 20 closer to the enclosure 10, and thus can be seen from the user who performs input operations on the enclosure 10. Specific information such as serial number or identification code, which is displayed on the information medium M itself, needs to be input into the information processor 1 while the information is read from or rewritten into the information medium M, an input operation can be performed on the information processor 1 while the information medium M is being within the wireless communication region W of the wireless communication module 11 without being removed from the holder 14.

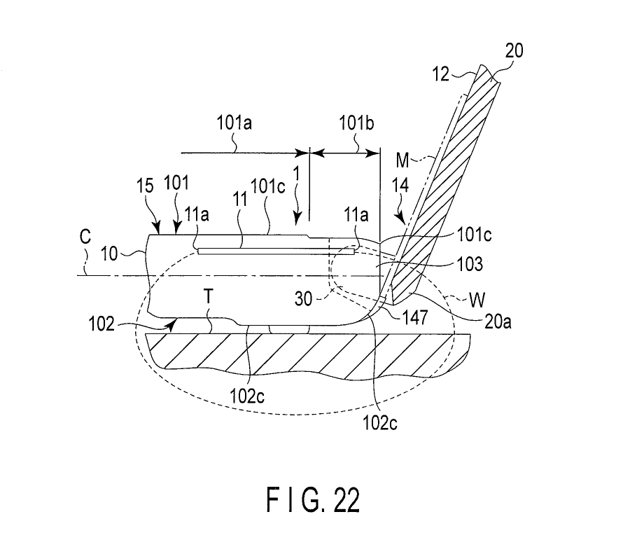

An information processor 1 according to the twelfth embodiment will be described with reference to FIG. 22. The information processor 1 shown in FIG. 22 is of the same clamshell type as that according to the eleventh embodiment. In the information processor 1, a wireless communication module 11 is arranged inside a enclosure 10 closer to a first face 101 similarly as in the eleventh embodiment. That is, the wireless communication module 11 is arranged closer to the first face 101 from the center face C of the enclosure 10. The enclosure 10 has a rotation shaft of a hinge 30 between the first face 101 and a second face 102. The display 20 is coupled to the rotation shaft of the hinge 30 at a position offset toward the display face side. Thus, when the display 20 is rotated about the rotation shaft of the hinge 30 relative to the enclosure 10 at an angle of 90° or more, an edge 20a of the display 20 coupled to the hinge 30 moves to a position covering a third face 103 as an edge of the enclosure 10 coupled to the hinge 30. The wireless communication module 11 forms a wireless communication region W toward the second face 102.

The holder 14 includes a surface of the display 20 facing the enclosure 10, and a hook protrusion 147 protruding from the enclosure 10 toward an end of the display 20 closer to the hinge 30. When the enclosure 10 is placed on a flat table T such as desk, and the display 20 is held to be opened about the hinge 30 at an angle of 90° or more while it overlaps with the enclosure 10 to be closed, the holder 14 supports an information medium M. In the state, part of the information medium M enters the wireless communication region W formed by the wireless communication module 11 as shown in FIG. 22.

With the information processor 1 according to the twelfth embodiment, the information medium M set in the holder 14 is supported on the display face side of the display 20 closer to the enclosure 10 similarly as in the eleventh embodiment, and thus can be seen from the user who performs input operations on the enclosure 10. Thus, when specific information displayed on the information medium M itself needs to be input into the information processor 1 while the information is read from or rewritten into the information medium M, an input operation can be performed on the information processor 1 while the information medium M is being within the wireless communication region W of the wireless communication module 11 without being removed from the holder 14.

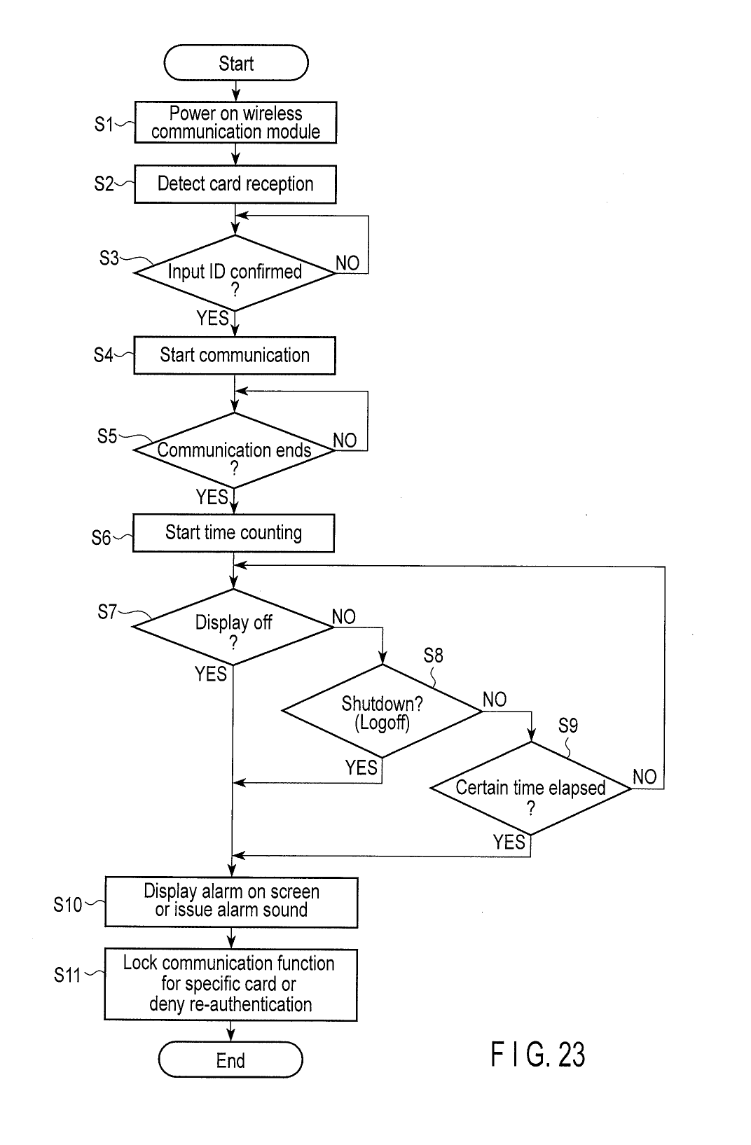

The functions for not forgetting to recover the information medium M after the information medium M is mounted on the holder in the information processor 1 according to the second to twelfth embodiments will be described with reference to the flowchart of FIG. 23. There will be described an example in which the information medium M is a card.

At first, when a card as the information medium M mounting an IC chip thereon is mounted on the holder 14 and the wireless communication module 11 is activated, the power supply is turned on (S1) and the card within the wireless communication region W is detected (S2). The information processor 1 requests the ID of the detected card for the user. When the ID is input, the ID is collated with information inside the card (S3), and when confirmed, communication is started (S4).

The information processor 1 confirms whether the communication for the card set in the holder 14 has been terminated (S5), and when it is confirmed that the communication has been completed, measures a time for which the card is left in the holder 14 (S6). At this time, the information processor 1 searches the card within the wireless communication region W by the wireless communication module 11, and when a card having the same ID is found, may display, on the display 20, that the card has not been recovered to the user.

When the time measuring is started, a determination is made as to whether the display 20 is closed (S7). When the display 20 is not closed, it is determined that the user is near the information processor, and then a determination is made as to whether a shutdown or logoff operation has been performed (S8). When the shutdown or logoff operation has not been performed, a determination is made as to whether a certain period of time has not elapsed since the time measuring was started (S9). When a certain period of time has not elapsed, a confirmation is continued as to whether the display has not been closed again (S7) or whether the shutdown or logoff operation has not been performed (S8).

When it is confirmed that the display is closed, when it is confirmed that the shutdown or logoff operation has been confirmed, or when a certain period of time has elapsed, the information processor 1 displays an alarm for notifying that the card is not recovered on the screen or issues an alarm sound (S10). The alarm display or alarm sound is stopped when the card is recovered from the holder 14, when it is confirmed by the wireless communication module 11 that no card is present within the wireless communication region W, or when the leaving time is extended by an input operation.

When a certain period of time has further elapsed since an alarm display or alarm sound was issued, the information processor is locked so as not to accept the wireless communication function for a specific card, or denies re-authentication of the specific card (S11). The “wireless communication function for a specific card” includes the total functions of accessing information within the specific card by the wireless communication module 11, such as permission of an input operation into the information processor or permission of communication with other device on the basis of the card ID or password information. “Deny re-authentication of the specific card” means that the information in the specific card cannot be read by other wireless communication module 11.

In this way, even when the card stored in the holder 14 is left, unauthorized use of the card can be prevented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
an enclosure comprising a first face comprising an input region for receiving an input and a surrounding region extending around the input region, a second face opposite to the first face, a plurality of corner portions, and a center portion distant from the corner portions and configured to house a component; and
a wireless communication module comprising a side extending along the first face or the second face in which at least part of the side is inside the enclosure closer to the corner portion at a position overlapping with the surrounding region, the wireless communication module configured to communicate through at least the second face.

2. The information processor of claim 1, wherein
the wireless communication module is distant from the outer peripheries of the first face and the second face, and
the part of the side overlaps with the surrounding region.

3. The information processor of claim 2, wherein
the enclosure comprises a third face over the outer periphery of the first face and the outer periphery of the second face.

4. The information processor of claim 3, further comprising:
a holder configured to hold at least part of an information medium comprising an IC chip therein within a wireless communication region formed by the wireless communication module.

5. The information processor of claim 4, wherein
the holder comprises a hook configured to project out from the second face of the enclosure and holds an outer edge of the information medium along the second face.

6. The information processor of claim 4, wherein
the holder comprises a case configured to attach to the second face of the enclosure to accommodate the information medium along the second face.

7. The information processor of claim 6, wherein
the case comprises a window through which at least part of the stored information medium can be seen.

8. The information processor of claim 6, wherein
the case comprises an opening through which at least part of the stored information medium can be touched.

9. The information processor of claim 6, wherein
the case comprises a transparent member through which at least part of the stored information medium can be seen from outside.

10. The information processor of claim 4, wherein
the holder comprises a holding mechanism configured to hold the information medium.

11. The information processor of claim 4, wherein
the enclosure comprises a plurality of legs at the both sides of the wireless communication region on the second face, and
the holder comprises a support groove formed at a side of each of the legs and the support grooves opposing each other.

12. The information processor of claim 4, wherein
the holder comprises a slot configured to overlap with the wireless communication module and the second face, and accommodates the information medium along the second face.

13. The information processor of claim 12, wherein
the enclosure comprises a cover configured to cover the slot.

14. The information processor of claim 4, wherein
the enclosure comprises a mooring hole configured to detachably couple a lock device to a region at least partially interfering with a trajectory of the information medium when the information medium is taken from the holder along the second face.

15. The information processor of claim 13, wherein
the enclosure comprises a mooring hole configured to detachably couple a lock for the cover covering the slot to the enclosure.

16. The information processor of claim 4, wherein
the holder comprises at least one sucker on the second face configured to catch the information medium.

17. The information processor of claim 4, wherein
the holder comprises at least one adhesion member on the second face configured to catch the information medium.

18. The information processor of claim 4, further comprising:
a display configured to couple to the enclosure via a hinge,
wherein the holder comprises a surface of the display facing the enclosure, and a hook protrusion formed closer to the hinge of the display, the holder is configured to support the information medium while the display is held at an angle of 90° or more about the hinge from where the display overlaps with the enclosure.

19. The information processor of claim 4, further comprising:
a display configured to couple to the enclosure via a hinge,
wherein the holder comprises a surface of the display facing the enclosure, and a hook protrusion on an outer face of the enclosure at a position interfering with a plane along the surface of the display, the holder is configured to support the information medium while the display is held at an angle of 90° or more about the hinge from where the display overlaps with the enclosure.
